(19) United States
(12) Patent Application Publication
(10) Pub. No.: US 2010/0277338 A1
(43) Pub. Date: Nov. 4, 2010

(54) SYSTEM AND METHOD FOR POSITIONING AND TRACKING MOBILES WITHIN A STRUCTURE

(76) Inventor: Jean-Louis Laroche, Montreal (CA)

Correspondence Address: MAIER & MAIER, PLLC, 1000 DUKE STREET, ALEXANDRIA, VA, 22314, US

(21) Appl. No.: 12/431,943

(22) Filed: Apr. 29, 2009

(51) Int. Cl. G08B 5/22

(52) U.S. Cl. 340/825.49

(57) ABSTRACT

Method and a system for positioning and tracking a mobile within an infrastructure. The method includes transmitting, from a first aerial, a first signal generated in accordance with a first characteristic for addressing specifically a first mobile, and the first aerial located at a position outside of the infrastructure; upon receiving the first signal and detecting the first characteristic, the first mobile generating and transmitting a second signal with a second characteristic; receiving, at the first aerial and other additional aerials, the second signal at respective reception times, the other aerials located at respective pre-determined positions outside of the infrastructure; determining a position of the first mobile based on: the respective reception times; the position of the first aerial; and the respective positions of the other aerials; and outputting the position of the first mobile to a display device, for display relative to a given location.

### CROSS-REFERENCE TO RELATED APPLICATIONS

This is the first application filed in relation to this matter.

### TECHNICAL FIELD

The present description relates to the locating of objects in space, and more particularly to the methods and systems for positioning and tracking mobiles moving within an area or an infrastructure, using RF signaling and processing.

### BACKGROUND

When a disaster occurs, first response personnel risk their lives to save that of others. There have been many situations where people have died or suffered injuries which could have been prevented if it had not been for the conditions which made it extremely difficult to locate people lost in a building, or hidden by rumbles, fire walls, smoke or any other structure.

While multiple systems and methods exist for tracking objects in space, they typically possess particular technical specifications which generally address issues related to specific types of environments or specific applications in view of a given and somewhat limited range of situations. The performance of such systems can be significantly affected when used in conditions under which they have not been designed to operate. Such limitations may relate to usable tracking ranges and/or environmental factors and effects rendering the tracking of objects difficult if not impossible. Other limitations may also include transportability and adaptability of the entire system to be operated in various different locations. Such systems are also not suitable for effectively tracking people or objects such as robots within a wide range of hazardous environments or disaster areas for example.

A need therefore exists for a positioning and tracking system and method which at least mitigates the above-mentioned limitations.

### SUMMARY

The proposed system and method provides for the positioning, tracking and optional guidance of mobiles moving within a given area or infrastructure.

More particularly, there is provided a method for positioning and tracking mobiles within an infrastructure. The method comprises: transmitting, from a first aerial, a first signal generated in accordance with a first characteristic for addressing specifically a first one of the mobiles, and the first aerial being located at a pre-determined position outside of the infrastructure; upon receiving the first signal and detecting the first characteristic, the first mobile generating and transmitting a second signal with a second characteristic different from the first characteristic; receiving, at the first aerial and at each one of at least three additional aerials, the second signal at respective reception times, the at least three additional aerials located at respective pre-determined positions outside of the infrastructure; determining a position of the first mobile based on: the respective reception times; the pre-determined position of the first aerial; and the respective pre-determined positions of the at least three additional aerials; and outputting the position of the first mobile to a display device, for display relative to a given location.

Accordingly, there is provided a system for positioning and tracking mobiles within an infrastructure. The system comprises a mobile free to be moved throughout the infrastructure and a transceiving device and at least three receiving devices located at respective pre-determined positions outside of the infrastructure. The transceiving device is for transmitting a first signal generated in accordance with a first characteristic for addressing specifically the mobile. Each one of the transceiving devices and the at least three receiving devices for receiving at respective reception times a second signal sent from the mobile. The system further comprises a positioning module for determining a position of the mobile within the infrastructure based on the respective reception times and the respective pre-determined positions. The system further comprises an output device for communication with the positioning module, and for outputting the position of the mobile, wherein the mobile generates and transmits the second signal upon detecting the first characteristic of the first signal, the second signal having a second characteristic different from the first characteristic.

Accordingly, there is provided, in a processor device, a method for positioning and tracking mobiles within an infrastructure. The method comprises: sending a first command to a first aerial, the first command instructing the first aerial to transmit a first signal with a first characteristic for addressing specifically a first one of the mobiles, the first aerial being located at a pre-determined position outside of the infrastructure; receiving from the first aerial and each one of at least three additional aerials, respective reception times at which a second signal is respectively received, the second signal being generated by the first mobile upon the first mobile detecting the first characteristic of the first signal, the second signal having a second characteristic different from the first characteristic, and the at least three additional aerials being located at respective pre-determined positions outside of the infrastructure; determining a position of the first mobile based on: the respective reception times; the pre-determined position of the first aerial; and the respective pre-determined positions of the at least three additional aerials; and outputting the position of the first mobile to a display device, for display relative to a given location.

Accordingly, there is provided a system for positioning and tracking mobiles within an infrastructure. The system comprises a processor device for communication with a memory device; a display device for communication with the processor device; and an application module comprising instructions, stored within the memory device, for allowing the processor device to: send a first command to a first aerial, the first command instructing the first aerial to transmit a first signal with a first characteristic for addressing specifically a first one of the mobiles, the first aerial being located at a pre-determined position outside of the infrastructure; receive from the first aerial and each one of at least three additional aerials, respective reception times at which a second signal is respectively received, the second signal being generated by the first mobile upon the first mobile detecting the first characteristic of the first signal, the second signal having a second characteristic different from the first characteristic, and the at least three additional aerials being located at respective pre-determined positions outside of the infrastructure; determine a position of the first mobile based on: the respective reception times; the pre-determined position of the first aerial; and the respective pre-determined positions of the at least three additional aerials; and output the position of the first mobile to the display device, for display relative to a given location.

The term infrastructure of the present description is intended to refer to any framework, permanent installations, areas of public works, fixed structural resources (as buildings or equipment areas), any structure, underground facility, construction, transportation means such as trains, subway networks, aircrafts, or any other type of structure defined by a network of passages or arrangements within which objects, living organisms, or people may be displaced.

### BRIEF DESCRIPTION OF THE DRAWINGS

Further features and advantages of the present invention will become apparent from the following detailed description, taken in combination with the appended drawings, in which:

FIG. 1 is a schematic view of a system for positioning and tracking mobiles within an infrastructure, in accordance with an embodiment;

FIG. 2 is a schematic view of the processing unit of FIG. 1, in accordance with an embodiment;

FIG. 3 is a schematic view of one of the mobiles of FIG. 1, in accordance with an embodiment;

FIG. 4 is a schematic view of one of the aerial devices of FIG. 1, in accordance with an embodiment;

FIG. 5 is a schematic illustrating an application of the system of FIG. 1, in accordance with an embodiment; and

FIG. 6 is a block diagram of a method for positioning and tracking mobiles within an infrastructure, in accordance with an embodiment.

It will be noted that throughout the appended drawings, like features are identified by like reference numerals.

### DETAILED DESCRIPTION

The proposed system and method is designed to locate, position and track in real time and in three dimensions, mobiles which may be worn by people, or moving or static objects, from a remote location. The system and method is adaptable to be used as a tracking and positioning system by first response personnel of disaster scenes.

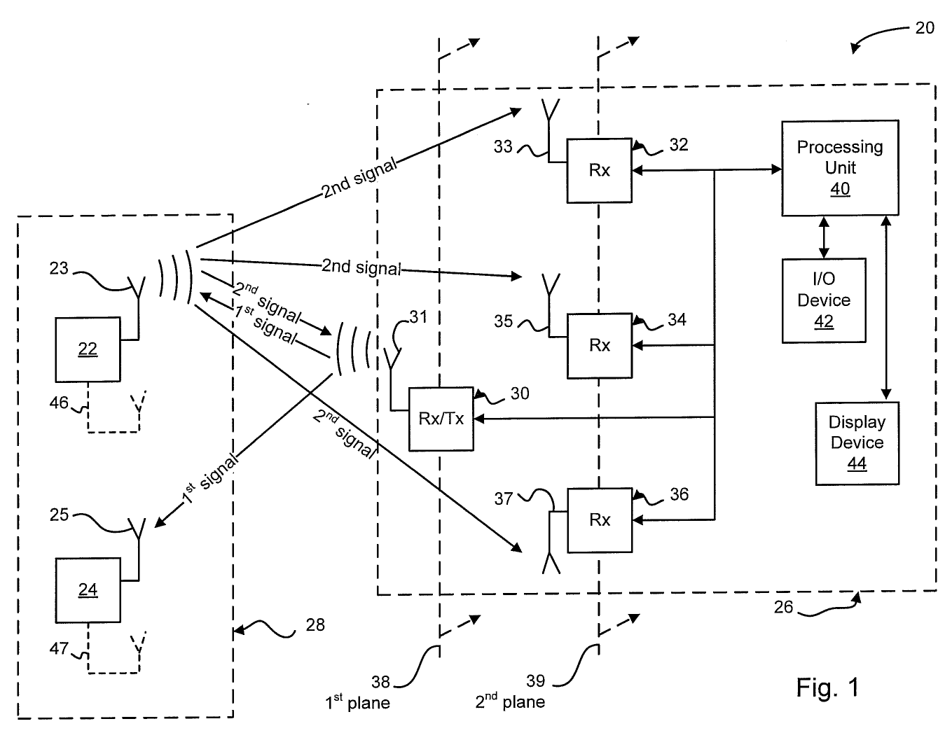

Referring now to the drawings, and more particularly to FIG. 1, there is illustrated, in accordance with an embodiment, a schematic view of a system 20 for positioning and tracking a first mobile 22 with its aerial(s) 23 (also referred to as an antenna) and a second mobile 24 with its aerial 25, from a remote location 26, the mobiles 22 and 24 being movable within an infrastructure 28.

Aerial devices (also referred to as antenna devices or receiving devices) 30, 32, 34 and 36, have respective aerials 31, 33, 35 and 37, and are located remotely from the infrastructure 28. They are also in communication with a processing unit 40, which has an input/output device 42 and a display device 44.

It is noted that the aerial devices 30, 32, 34 and 36 may respectively only have an aerial. In this alternative, any circuitry (not shown) for detecting a characteristic feature of a received signal and for implementing a characteristic feature of the first signal is implemented within the processing unit 40.

Of the four aerial devices 30, 32, 34 and 36 shown, at least one of them (here aerial device 30) is a transceiving device, or is capable of both transmitting and receiving. While the aerial device 30 may only have a transmitting device with transmitting capabilities, the remaining aerial devices (here aerials 32, 34 and 36) may only be receiving devices.

All of the aerials 31, 33, 35 and 37 are located in pre-determined positions. In one embodiment, at least one of the aerials 31, 33, 35 and 37 (here aerial 31) is positioned in a plane 38 separate from a plane 39 of the at least three other aerials (here aerials 33, 35 and 37). A calibration process may be used to determine the position of these aerials 31, 33, 35 and 37 prior to operating the system 20 to position a mobile 22 or 24.

The aerial 31 of the aerial device 30 transmits a first signal to all of the mobiles 22 and 24. The first signal is however addressed specifically at one mobile 22 and has characteristic features such as a given spectrum bandwidth, at a given frequency, an amplitude versus time profile for one pulse, a given carrier modulated with an information signal using a given modulation technique, or any other signal feature.

Still referring to FIG. 1, while all the mobiles 22 and 24 may receive the first signal addressed to a specific mobile 22, the one mobile 22 to whom the first signal is addressed, generates and transmits a second signal. In other words, a characteristic of the first signal, such as a modulated information signal corresponding to an address or an identification number of the mobile 22, once detected and decoded by the one mobile 22, acts as a trigger for the mobile 22 to generate and send out the second signal.

The second signal has a characteristic feature which is different from at least one of the characteristic features of the first signal. The second signal may have a different spectrum bandwidth, centered at a different frequency, a different amplitude versus time pattern, or a different information signal modulated using a given recognizable technique, or any other signal feature that is different from one or more of the characteristic features of the first signal.

Still referring to FIG. 1, each one of the aerials 31, 33, 35 and 37 receive, at respective reception times, the second signal sent from the aerial 23 of the mobile 22. The reception times are transferred from the aerial devices 30, 32, 34 and 36, to the processing unit 40, via wire, coaxial cable, fiber optic cable or any other communication means such as wireless transmission in accordance with a given protocol. A calibration of the system 20 may take into account effects of this transmission.

As an alternative to communicating the respective reception times of the second signal at each one of the aerials 31, 33, 35 and 37 to the processing unit 40, each one of the aerial devices 30, 32, 34 and 36 detect a phase and a cycle count associated with the received second signal, and transmits their detected phase and cycle count to the processing unit 40 for comparison with a given reference phase and count.

As yet another alternative to communicating the respective reception times or phases and cycle counts, when a circuitry of an aerial device (30, 32, 34 and 36) does not permit the pre-processing of a received signal to detect a reception time, phase and/or count cycle, the received signal is directly transferred to the processing unit 40 which has the devices to detect these.

The processing unit 40 then determines a position of the one mobile 22 based on the respective reception times (or the phases, or cycle counts of the received signals) and the pre-determined positions of each one of the aerials 31, 33, 35 and 37 of the aerial devices 30, 32, 34 and 36, which are kept fixed during a positioning operation.

The position of the mobile 22 is then outputted to a client application or to a user via a display of the position on the display device 44, or to any other type input/output device 42, in any given format. For example, position information associated to one mobile can be outputted to a client application for subsequent processing, or may be appropriately formatted to be outputted to a user in an audio format or as an alarm or a trigger when approaching a preset position.

As an option, still in reference to FIG. 1, the mobiles 22 and 24 may have an additional aerial 46 and 47 respectively, to transmit any type of data acquired by an optional sensor (not shown) in communication with the mobile 22 or 24. The sensor may be any type of sensor which measures or acquires data pertaining to an environment of the mobile 22. As an example, the sensor may be a camera which acquires images, a sensor for measuring a biological parameter of a person or object wearing the sensor, a sensor for detecting the presence of any hazardous composition in a vicinity of the mobile 22, or any other sensor which can be used to detect any given environmental parameter.

Finally, it is noted that more than four aerial devices such as devices 30, 32, 34 and 36 may be used, as long as at least one of them is or comprises a transmitting device to transmit the first signal to each mobile; e.g., the transmit device could be on a fifth (independent) aerial device not equipped with a receiver.

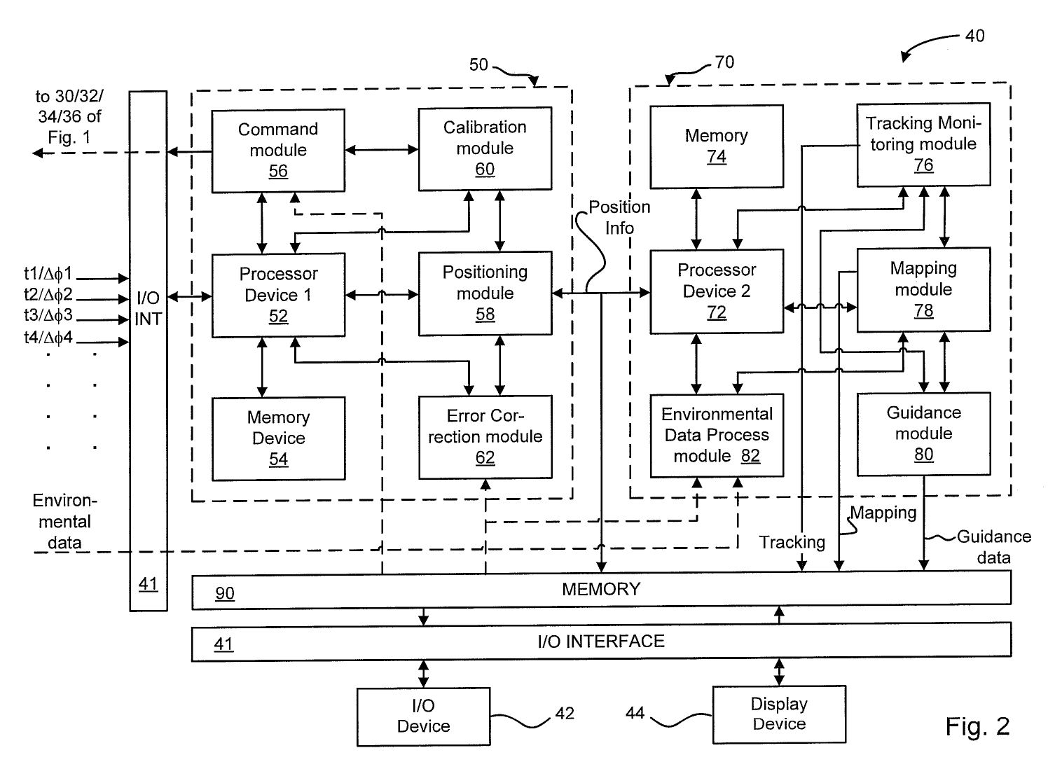

Referring now to FIG. 2, there is shown a schematic view of the processing unit 40 of FIG. 1 in accordance with an embodiment. The processing unit 40 is illustrated with the input/output (I/O) device 42 and the display device 44 for convenience purposes. In this embodiment, the processing unit 40 is schematized as having an input/output interface 41 and two functional modules: a first module 50 and an optional second module 70.

The first module 50 is now described in relation to FIG. 2 and occasional reference to the entire system 20 as illustrated by FIG. 1.

The first module 50 has a processor device 52 in communication with a memory device 54, a command module 56, a positioning module 58, a calibration module 60 and an error correction module 62.

The second module 70 also optionally has its own processor device 72 and memory device 74, in communication with a tracking and monitoring module 76, a mapping module 78, a guidance module 80 and an environmental data processing module 82.

Both of the modules 50 and 70 share an optional memory device 90 and the I/O interface 41. The optional memory device 90 stores any in-going and outgoing data as outputted by the system to a user, or as inputted by a user to a system 20. This memory is optional. The interface 41 displays the outputted data in various customizable and upgradable types of formats, as preferred by a user

In reference to both FIGS. 1 and 2, the first module 50 receives respective reception times (or phases and cycle counts) from each one of the aerial devices 30, 32, 34 and 36, which are detected from the second signal as received by each one of the aerials 31, 33, 35 and 37. As detailed hereinabove, the second signal is initially emitted by a mobile for which a position is sought.

As an alternative, the first module 50 receives various versions of the second signal as respectively received by each one of the aerials 31, 33, 35 and 37, and devices later described in relation to the mobiles 22 or 24, are produced in the first module 50 to determine the reception times, or phase and cycle counts.

The processor device 52 processes the received signal or data as instructed from the various modules 56 to 62, each storing data and/or instructions which implement the processing unit 40 and system 20 accordingly.

The positioning module 58 allows the processor device 52 to process signals or data received from each one of the aerials devices 30, 32, 34 and 36 and determines differences between the reception times of the second signal as received by at least three of the aerial devices with respect to at least one of the aerial devices. This technique is commonly known as time difference of arrival (TDOA). In one embodiment, the at least one aerial device with respect to which the time differences are determined corresponds to the aerial device 30 which is in the plane separate from the others. Any other techniques for calculating a position using a plurality of reception times at respective aerials known to those skilled in the art is meant to be encompassed in this description including, more particularly, time of arrival (TOA)_and angle of arrival (AOA).

As a result, the first module outputs a position of a mobile from which the second signal is received. This position information is outputted by the processing unit 40, via the optional memory device 90, interface 41, to any output device such as display 44. According to an embodiment, the position information is also communicated to the optional second module 70.

The command module 56 is used to issue commands for a given first signal to be generated and transmitted by the at least one aerial 31. The command module 56 may also be used during calibration to order transmission of a given signal for subsequent calibration purposes. This module 56 is in communication with the I/O device 42 via the I/O interface 41, and is controllable by a user of the system 20. The command module 56 also serves to perform updates, changes or enter data for use by any one of the module 58, 60 and 62 via the processor 52 and memory 54.

An optional calibration module 60 is used to pre-calibrate the system 20. Calibration is used to pre-determine the respective positions of at least three of the aerials 31, 33, 35 and 37 with respect to a remaining aerial. All of their positions may also be pre-determined. Various calibration techniques may be used, such as a triangulation of one of the aerials with at least three others.

The error correction module 62 enables the detection and correction of errors which may be caused by effects such as signal reflections. Various correction techniques may be used. Non-limiting examples include using self-learning, recursive software which may use previous mobile positions to determine a pattern and make conclusions as to error probabilities and thereby determine a most probable solution. Other techniques may involve the use of error compensation schemes based on error differences between two or more positions of a mobile as determined for two subsequent time intervals. An additional aerial may also be used on a mobile to send the second signal in order to completely separate the address receiving circuit from the pulse transmitting circuit. It is also possible to use different frequency bands; i.e., one for the addressing and another for the pulse. In such a case, the antenna must be different to properly transmit the different frequency.

The second optional module 70 is now described again in relation to FIG. 2 and occasional reference to the entire system 20 as illustrated by FIG. 1.

The position information communicated to the module 70 is subsequently used by the various modules 76 to 80 as implemented by the processor device 72 in conjunction with the memory 74. Similarly to the first module, the processor device 72 is implemented to perform the actions as dictated by the modules. As position information is accumulated at several time intervals for a same mobile, the tracking/monitoring module 70 accumulates the information and generates tracking data indicative of a path taken by the mobile in time.

The mapping module 78 generates a 2-D or 3-D map of the infrastructure within which the mobile is moving. Position information associated with mobiles located in various strategic positions within the infrastructure is used to generate a first gross mapping. Subsequently accumulated position information on a given number of mobiles traveling within the infrastructure is also accumulated to generate mapping data. In addition or alternatively, a user may enter quantitative or qualitative data pertaining to the infrastructure, such as a number of levels/floors if it is a building, a height or depth, a wall composition, an area, or any other information. User available electronic maps may also be entered. This data is first received by the environmental data processing module 82, which indexes such environmental data for use by anyone of the modules 76 to 80. The position of each mobile is constantly memorized the sum of all those x,y,z positions draw the path followed by each mobile being tracked and a software will draw doors, staircases etc. where appropriate.

The guidance module 80 uses the tracking data and the mapping data outputted by the tracking module 76 and the mapping module 78 to generate guidance data. The guidance data is outputted to an output device 42 or 44 via the interface 41 and optional memory 90. Future tracking data sets are generated for one mobile, based on the mapping data and the tracking data associated with the one mobile. As an non-limiting example, if an end position is entered in the processing unit 40 by a user, such as in the case where a person or moving object wearing a first mobile wishes to be guided towards a position of another mobile, the guidance module 80 issues guidance data using best route calculations, the mapping data and the tracking data of the first mobile worn by the person being guided. The guidance data is outputted via the interface 41, to any output device 42 or 44. The guidance data may also be sent back to a mobile being guided, via a dedicated additional aerial.

In addition to the above, it is noted that the environmental data processing module optionally receives environmental data sent from an aerial of a mobile, such as aerial 46 or 47 as described in relation to FIG. 1 above, the environmental data being acquired by a sensor in a vicinity of the mobile.

Finally, still in reference to FIG. 2, modules 50 and 70 may be regrouped into one single unit and use the same processing power or processor device.

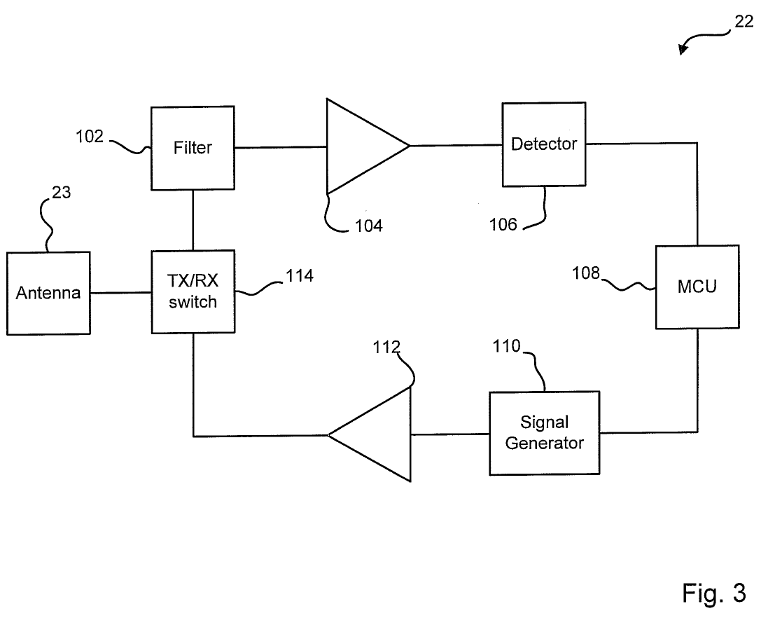

Referring now to FIG. 3, there is shown a schematic view of one of the mobiles 22 of FIG. 1, with only one aerial 23, in accordance with an embodiment. According to another embodiment, the mobile 22 comprises more than one aerial. For example, two aerials could be used for transmission while a third aerial could be used for reception. Also, two aerials could be used for transmission and one or both of them could be used for reception.

The mobile 22, in addition to having the aerial 23, has a filter 102, an amplifier 104, a feature detector (also referred to as a decoder) 106, a micro-controller unit (MCU) 108, a signal generator 110, another amplifier 112 and a switching device 114.

The filter 102 filters out a signal received by the antenna 23, to output only a portion of the signal. The bandwidth of the filter 102 is set to correspond to the bandwidth of the first signal sent out by the first aerial 31 (refer to FIG. 1). The amplifier 104 is used to boost the gain of the filtered signal for subsequent treatment by the detector 106.

The detector 106 identifies a pre-set characteristic feature to be found in the received signal. Only when the pre-set characteristic feature is detected, the MCU 108 is triggered to issue a command to the signal generator 110 to generate a second signal in accordance to another different pre-set characteristic. The generated signal is optionally sent to the amplifier 112 to sustain an increase in gain before being emitted out of the antenna 23.

Still in reference to FIG. 3, the signal generator 110 is set to generate the second signal within a frequency band and according to a pulse shape in time, with given rise and fall times. The frequency band may be chosen in view of specific environmental or structural factors of the infrastructure, based on attenuation factors related to various frequency bands. Non-limiting examples of possible frequency bands include the industrial, scientific and medical (ISM) bands, such as the band centered at 915 MHz, with a 26 MHz bandwidth. Frequencies chosen within a range set between an upper range of the Very High Frequency (VHF) band and a lower range of the Ultra High Frequency (UHF) band can also be used. In theory, the pulse could be sent at any chosen frequency, from 1 KHz to just below infrared frequencies. Practical reasons (antenna size, density of material to be penetrated, local rules and regulations, etc) will dictate the center frequency of the pulse for a given application.

Other non-limiting examples of characteristic signal features include signal shapes, the rise and fall time and amplitude profile of a pulse versus time or frequency, within the frequency band chosen. The amplitude profile can be set to be relatively flat and chosen in accordance with Nyquist criteria.

The switching device 114 switches the antenna 23 into a receiving or a transmitting mode. In the case where two different antennae (not shown) each dedicated to transmission purposes is used instead, then the switching device 114 is no longer used.

The detector 106 can be adapted to receive and detect signals which are modulated according to a direct sequence spread-spectrum technique, an orthogonal frequency division multiplexing (OFDM) or any other technique known to those skilled in the art and best adapted for the environment in which the system is operating.

It is noted that the mobile 22 does not have a commutator (unless its transceiver and receptor use the same aerial) (unless its transceiver and receptor use the same aerial) since the first signal is not retransmitted by the mobile 22. Instead, the mobile 22 generate the second signal, optionally after a given pre-set time delay which is implemented by delay circuitry.

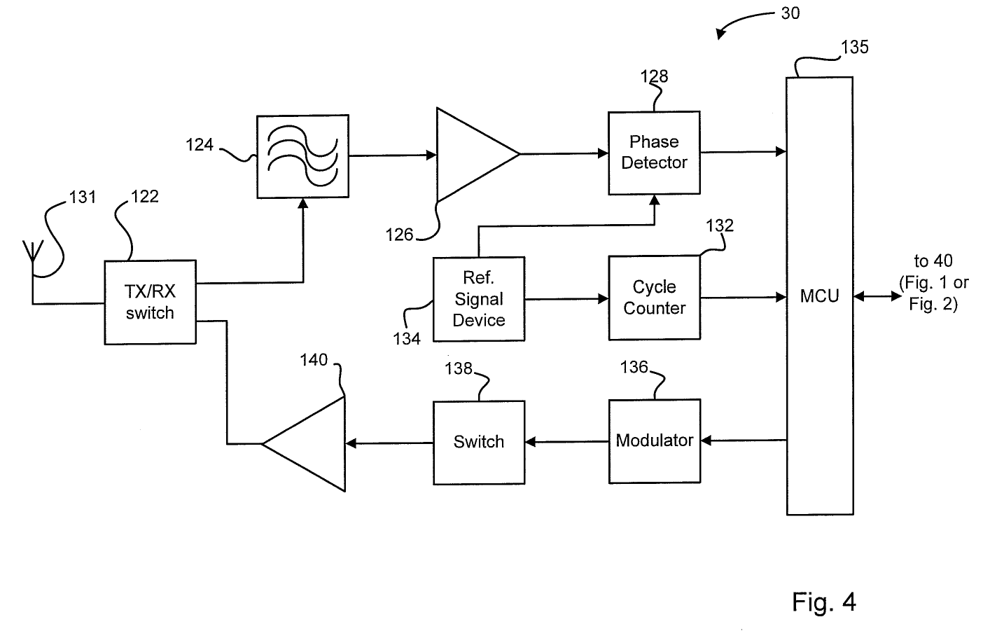

Now referring to FIG. 4, there is illustrated a schematic of one of the aerial devices of FIG. 1 (here aerial device 30), in accordance with an embodiment.

Aerial device 30, in addition to aerial 31, has a switching device 122 for switching between receiving and transmitting mode, a signal detector 124, an amplifier such as a low noise amplifier (LNA) 126, a phase detector 128, a cycle counter 132, a reference signal generator 134, an MCU 135, a modulator and signal generator 136 with a switching device 138, and a power amplifier 140.

When in receiving mode, the detector 124 detects the second signal as received from a mobile and sends it to the phase detector 128 via optional amplifier 126. The phase detector detects a phase 128 associated with the second signal as received, in comparison with a reference signal from the reference signal of reference signal generator 132. The cycle counter 130 determines a cycle count associated with the second signal received in comparison with the reference signal. The word cycle counter is meant to incorporate any system which approximates the distance within a wavelength. Both the phase and the cycle count are outputted to the MCU 135 and transferred to the processing unit 40 for subsequent treatment. The phase detector and the cycle counter is one of many examples of measurement means which may be used to ultimately determine a position of the mobile.

When in transmission mode, the MCU 135 sends a command to the modulator and signal generator 136 to generate a modulated signal. The command contains a given mobile address or specifies a characteristic feature according to which the modulator 136 generates the first signal to be sent out for a single mobile to recognize.

The reference signal generator 134 may be implemented at a pre-set center frequency in accordance with the frequency band chosen to generate the second signal at one of the mobile. A possible frequency band, as detailed hereinabove, is an ISM frequency band, such as the second region centered at 915 MHz or within the 902-928 MHz.

Still in reference to FIG. 4, the modulator and signal generator 136 may be a direct sequence spread-spectrum (DSSS) modulator, under which the signal transmitted takes more bandwidth than the information signal that is being modulated thereon. Other modulators may also be used instead, provided the detector of the mobile is adapted to recognize the information signal modulated on the carrier.

The aerial devices of the system 20 in FIG. 1 need not all be transceiving devices. Aerial devices 32, 34 and 36 in FIG. 1 only have the signal detector 124, the amplifier 126, the phase detector 128, the cycle counter 132, the reference signal generator 134 and the MCU 135; the switching device 122, the amplifier 140, the switching device 138 and the modulator 136 being optional.

In reference to FIGS. 1 and 4, it is noted that a number of the devices shown in FIG. 4, less the aerials 31, 33, 35 and 37, are alternatively adapted and implemented to form part of the processing unit 40 of FIG. 1.

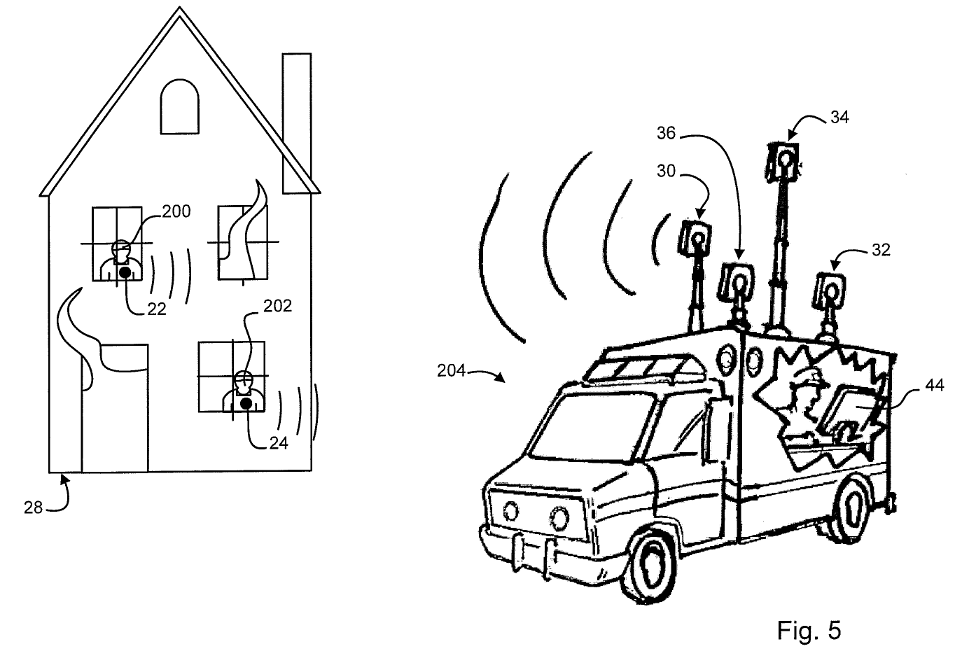

Now referring to FIG. 5, there is illustrated a schematic of an exemplary application of the system 20 of FIG. 1, in accordance with an embodiment.

The group of aerial devices 30, 32, 34 and 36 are located remote from the infrastructure 28, which is a building in this case. The mobiles 22 and 24 are each worn by persons 200 and 202. The display device 44 located remotely, in the truck 204 is used to display position information associated with each one of the mobiles 22 and 24, as determined by the system proposed herein.

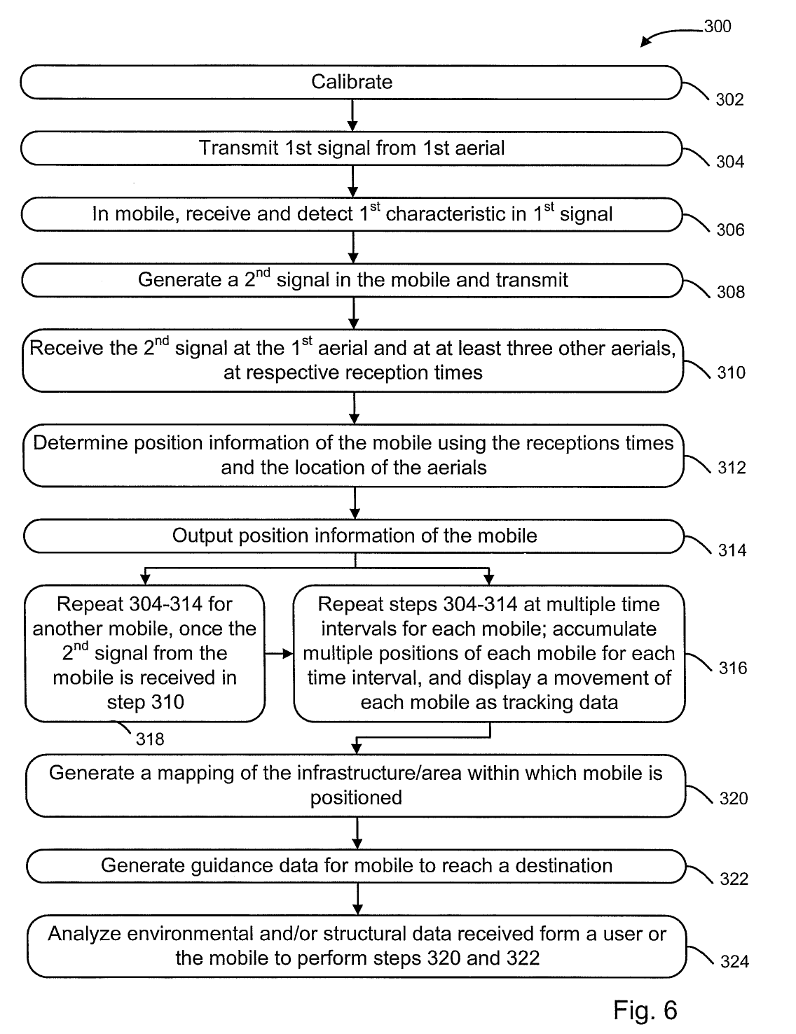

Now referring to FIG. 6, a block diagram provides steps of a method 300 for positioning and tracking mobiles within an infrastructure, in accordance with an embodiment.

The method 300 starts with step 302, in which the system is optionally calibrated prior to being operated to locate a mobile.

In step 304, a first signal is transmitted from one of multiple aerials located at a pre-determined position remote from an infrastructure in which multiple mobiles are free to move. The first signal has a first characteristic addressed specifically to one of the multiple mobiles.

In step 306, the mobile to which the first signal was addressed in step 304, receives the first signal and detects the first characteristic.

In step 308, once the mobile detects the first characteristic, it generates and transmits a second signal having a second characteristic different from the first characteristic.

In step 310, the multiple aerials located at pre-determined positions receive the second signal at a respective reception times (also referred to as arrival times). The reception times are determined using a number of different techniques. For example, a phase and a cycle count of the second signal received may be compared with a phase and cycle count of a reference signal.

In step 312, a processing unit determines a position of the mobile to which the first signal was addressed in step 304, based on the reception times and the pre-determined positions of at least three of the multiple aerials located remote from the infrastructure.

In step 314, the position is outputted for display or for use by a client application. The position is outputted with respect to timing information and at least one given location which can be chosen relative to the infrastructure, and set within a coordinate system oriented with respect to the chosen location for example. The timing indication referring to a specific time interval for example, within which the position was determined.

In optional step 316, steps 304 to 314 are repeated for a subsequent time interval. The position and timing information associated with each time interval are accumulated to generate tracking data indicative of a position versus time of the mobile.

In optional step 318, steps 304 to 314 are repeated with another first characteristic feature addressed specifically to another one of the mobiles. When there are multiple mobiles to be positioned within once infrastructure, each mobile is addressed one after each other, in a serial manner. A subsequent mobile is addressed by sending another first signal to the addressed to the subsequent mobile only after the second signal from the first mobile has been received.

In optional step 320, the position and associated timing information outputted in step 314 for multiple timing intervals as performed in step 316, are further used to generate mapping data indicative of an arrangement of the infrastructure. More specifically, the tracking data of step 316 is analyzed to determine possible movement areas, passages, walkways, rooms, doors, windows or any other inner structure or arrangement.

In optional step 322, the mapping and tracking data of steps 316 and 320 are used to generate guidance data for the mobile. The guidance data is indicative of a future path to be taken by the mobile to reach an end position or destination.

In optional step 324, environmental data received from and associated to an environment of any one of the mobiles, is used to update the mapping data and/or the guidance data.

The embodiments described above are intended to be exemplary only. The scope is therefore intended to be limited solely by the scope of the appended claims.

What is claimed is:

1. A method for positioning and tracking mobiles within an infrastructure, the method comprising:
transmitting, from a first aerial, a first signal generated in accordance with a first characteristic for addressing specifically a first one of the mobiles, and the first aerial being located at a pre-determined position outside of the infrastructure;
upon receiving the first signal and detecting the first characteristic, the first mobile generating and transmitting a second signal with a second characteristic different from the first characteristic;
receiving, at the first aerial and at each one of at least three additional aerials, the second signal at respective reception times, the at least three additional aerials located at respective pre-determined positions outside of the infrastructure;
determining a position of the first mobile based on: the respective reception times; the pre-determined position of the first aerial; and the respective pre-determined positions of the at least three additional aerials; and
outputting the position of the first mobile to a display device, for display relative to a given location.

2. The method of claim 1, comprising repeating the steps of transmitting, generating, receiving and determining for a second one of the mobiles, after the receiving of the second signal from the first mobile, the outputting comprising outputting a position of the second mobile.

3. The method of claim 1, comprising repeating the steps of transmitting, generating the second signal in the first mobile, receiving the second signal, and determining the position, for each one of a plurality of time intervals, and further comprising displaying a movement of the first mobile within the infrastructure as provided by a set of accumulated positions associated with each one of the time intervals.

4. The method of claim 1, wherein the first mobile is affixed to a person, the outputting comprising outputting a position of the person within the infrastructure.

5. The method of claim 1, wherein the first characteristic and the second characteristic respectively comprise a first and a second frequency.

6. The method of claim 5, wherein at least one of the first and the second frequency is selected based on an aspect of an environment of the mobiles.

7. The method of claim 5, wherein the second frequency is within a range set between an upper range of the Very High Frequency (VHF) band and a lower range of the Ultra High Frequency (UHF) band.

8. The method of claim 5, wherein the second frequency is within any one of the Industrial, Scientific and Medical (ISM) frequency bands.

9. The method of claim 5, wherein the second frequency is within a range of about 902 MHz to about 928 MHz.

10. The method of claim 1, wherein the transmitting a first signal comprises generating the first signal according to a first signal shape with respect to time, at a first frequency and over a first signal bandwidth.

11. The method of claim 1, wherein the first characteristic comprises an information signal modulated over a carrier within the first signal bandwidth.

12. The method of claim 11, wherein the generating the first signal comprises modulating the information signal using at least one of a spread-spectrum technique and an orthogonal frequency division multiplexing technique.

13. The method of claim 11, wherein the information signal comprises an address recognizable by the first mobile.

14. The method of claim 1, wherein the generating a second signal with a second characteristic comprises generating the second signal according to a second signal shape in time, at a second frequency and over a second signal bandwidth.

15. The method of claim 14, wherein the second frequency is pre-set and wherein the receiving, at the first aerial and at each one of at least three additional aerials, the second signal at respective reception times comprises comparing the second signal with respect to a reference signal at the second frequency.

16. The method of claim 15, wherein the comparing comprises measuring a phase and a cycle count associated with the second signal received, the respective reception times corresponding to the phase and cycle count measured for a respective one of the first and the at least three additional aerials.

17. The method of claim 14, wherein the generating the second signal according to a second signal shape in time comprises shaping the second signal with an amplitude profile having a rise time and a fall time, the amplitude profile being substantially uniform and set for a given Nyquist criteria.

18. The method of claim 1, wherein the transmitting a first signal comprises transmitting the first signal from a first plane, the first plane being separate from a second plane and formed by the respective pre-determined positions of the at least three additional aerials.

19. A system for positioning and tracking mobiles within an infrastructure, the system comprising:
a mobile free to be moved throughout the infrastructure;
a transceiving device and at least three receiving devices located at respective pre-determined positions outside of the infrastructure, the transceiving device for transmitting a first signal generated in accordance with a first characteristic for addressing specifically the mobile, and each one of the transceiving devices and the at least three receiving devices for receiving at respective reception times a second signal sent from the mobile;
a positioning module for determining a position of the mobile within the infrastructure based on the respective reception times and the respective pre-determined positions; and
an output device for communication with the positioning module, and for outputting the position of the mobile,
wherein the mobile generates and transmits the second signal upon detecting the first characteristic of the first signal, the second signal having a second characteristic different from the first characteristic.

20. The system of claim 19, wherein the transceiving device comprises at least one of a phase detector and a cycle counter to determine a respective reception time.

21. The system of claim 19, wherein the transceiving device comprises a signal modulator for generating the first signal where the first characteristic comprises a modulated information signal.

22. The system of claim 21, wherein the signal modulator is a direct sequence spread spectrum modulator.

23. In a processor device, a method for positioning and tracking mobiles within an infrastructure, the method comprising:
sending a first command to a first aerial, the first command instructing the first aerial to transmit a first signal with a first characteristic for addressing specifically a first one of the mobiles, the first aerial being located at a pre-determined position outside of the infrastructure;
receiving from the first aerial and each one of at least three additional aerials, respective reception times at which a second signal is respectively received, the second signal being generated by the first mobile upon the first mobile detecting the first characteristic of the first signal, the second signal having a second characteristic different from the first characteristic, and the at least three additional aerials being located at respective pre-determined positions outside of the infrastructure;
determining a position of the first mobile based on: the respective reception times; the pre-determined position of the first aerial; and the respective pre-determined positions of the at least three additional aerials; and
outputting the position of the first mobile to a display device, for display relative to a given location.

24. The method of claim 23, further comprising accumulating multiple positions in time for the first mobile to generate tracking data associated to the first mobile with respect to time.

25. The method of claim 24, further comprising analysing the tracking data to generate mapping data indicative of an arrangement of the infrastructure.

26. The method of claim 25, further comprising generating guidance data based on the mapping and tracking data, the guidance data being indicative of a future path to be taken by the first mobile to reach a given destination.

27. The method of claim 26, wherein at least one of the mapping and the guidance data is generated using environmental data associated with an environment of the first mobile.

28. A system for positioning and tracking mobiles within an infrastructure, the system comprising:
a processor device for communication with a memory device;
a display device for communication with the processor device; and
an application module comprising instructions, stored within the memory device, for allowing the processor device to:
send a first command to a first aerial, the first command instructing the first aerial to transmit a first signal with a first characteristic for addressing specifically a first one of the mobiles, the first aerial being located at a pre-determined position outside of the infrastructure;
receive from the first aerial and each one of at least three additional aerials, respective reception times at which a second signal is respectively received, the second signal being generated by the first mobile upon the first mobile detecting the first characteristic of the first signal, the second signal having a second characteristic different from the first characteristic, and the at least three additional aerials being located at respective pre-determined positions outside of the infrastructure;
determine a position of the first mobile based on: the respective reception times; the pre-determined position of the first aerial; and the respective pre-determined positions of the at least three additional aerials; and
output the position of the first mobile to the display device, for display relative to a given location.
